(19) United States
(12) Patent Application Publication
(10) Pub. No.: US 2024/0359950 A1
(43) Pub. Date: Oct. 31, 2024

(54) ELEVATOR SHEAVE

(71) Applicant: Mitsubishi Electric Corporation, Tokyo (JP)

(72) Inventors: Kazuki SAWATANI, Tokyo (JP); Tomoki YAMADA, Tokyo (JP)

(73) Assignee: Mitsubishi Electric Corporation, Tokyo (JP)

(21) Appl. No.: 18/291,930

(22) PCT Filed: Aug. 2, 2021
(86) PCT No.: PCT/JP2021/028608

§ 371 Date: Jan. 25, 2024

(51) Int. Cl. B66B 15/04; B66B 15/02

(52) U.S. Cl. CPC B66B 15/04; B66B 15/02

(57) ABSTRACT

Provided is a sheave for a lift, including: a base member having a cylindrical shape; a winding member that is coaxial with the base member and has a cylindrical shape with a diameter larger than a diameter of the base member; and a plurality of intermediate members provided between the base member and the winding member in a radial direction of the winding member. Each of the plurality of intermediate members includes: a first end portion connected to the base member; a second end portion connected to the winding member; a third end portion connected to the winding member at a position different from a position at which the second end portion is connected to the winding member in a circumferential direction of the winding member; and a branch portion formed between the first end portion and each of the second end portion and the third end portion.

### TECHNICAL FIELD

This disclosure relates to a sheave for a lift, which includes a plurality of intermediate members provided between a base member and a winding member.

### BACKGROUND ART

In Patent Literature 1, there is described a sheave mechanism for an elevator. This sheave mechanism includes a bearing portion and a sheave having a diameter larger than a diameter of the bearing portion. The sheave is provided concentrically with the bearing portion. The sheave and the bearing portion are to connected each other through intermediation of a plurality of spoke-shaped connecting members. A plurality of holes are formed between the sheave and the bearing portion.

### CITATION LIST

### Patent Literature

[PTL 1] JP 2012-240830 A

### SUMMARY OF INVENTION

### Technical Problem

In the above-mentioned sheave mechanism, each of the plurality of connecting members extends in a radial direction of the sheave mechanism. Each of the plurality of holes is formed between two connecting members that are adjacent to each other in a circumferential direction of the sheave mechanism. Thus, the sheave includes portions located on an outer side of the holes in the radial direction of the sheave mechanism and portions located on an outer side of the connecting members in the radial direction of the sheave mechanism, which are formed alternately in the circumferential direction of the sheave mechanism.

In the sheave, stiffness of the portions located on the outer side of the holes is lower than stiffness of the portions located on the outer side of the connecting members. Thus, when the sheave is subjected to a load from a rope, bending deformation in a direction toward a center of the sheave mechanism is liable to occur in the portions located on the outer side of the holes. When the above-mentioned bending deformation periodically and repeatedly occurs along with rotation of the sheave mechanism, oscillation is transmitted to a car. Hence, there is a problem in that ride comfort of the car degrades.

This disclosure has been made to solve the problem described above, and has an object to provide a sheave for a lift, which is capable of suppressing degradation of ride comfort of a car.

### Solution to Problem

According to this disclosure, there is provided a sheave for a lift, including: a base member having a cylindrical shape; a winding member that is coaxial with the base member and has a cylindrical shape with a diameter larger than a diameter of the base member; and a plurality of intermediate members provided between the base member and the winding member in a radial direction of the winding member, wherein each of the plurality of intermediate members includes: a first end portion connected to the base member; a second end portion connected to the winding member; a third end portion connected to the winding member at a position different from a position at which the second end portion is connected to the winding member in a circumferential direction of the winding member; and a branch portion formed between the first end portion and each of the second end portion and the third end portion.

### Advantageous Effects of Invention

According to this disclosure, it is possible to suppress the degradation of the ride comfort of the car.

### BRIEF DESCRIPTION OF DRAWINGS

FIG. 1 is a view for illustrating an example of a configuration of a lift including a sheave for a lift according to a first embodiment.

FIG. 2 is a view for illustrating another example of the configuration of the lift including the sheave for a lift according to the first embodiment.

FIG. 3 is a perspective view for illustrating a configuration of the sheave for a lift according to the first embodiment.

FIG. 4 is a front view for illustrating a configuration of a sheave for a lift according to a second embodiment.

FIG. 5 is a front view for illustrating a configuration of a sheave for a lift according to a third embodiment.

FIG. 6 is a front view for illustrating a configuration of a sheave for a lift according to a fourth embodiment.

FIG. 7 is a sectional view taken along the line VII-VII of FIG. 6.

FIG. 8 is a view for illustrating an example of a casting design used when a sheave for a lift according to a comparative example of a fifth embodiment is manufactured.

FIG. 9 is a view for illustrating an example of a casting design used when the sheave for a lift according to the fifth embodiment is manufactured.

FIG. 10 is a view for illustrating an example of a casting design used when the sheave for a lift according to the fifth embodiment is manufactured.

FIG. 11 is a view for illustrating an example of a casting design used when the sheave for a lift according to the fifth embodiment is manufactured.

FIG. 12 is a perspective view for illustrating a configuration of a sheave for a lift according to a sixth embodiment.

### DESCRIPTION OF EMBODIMENTS

### First Embodiment

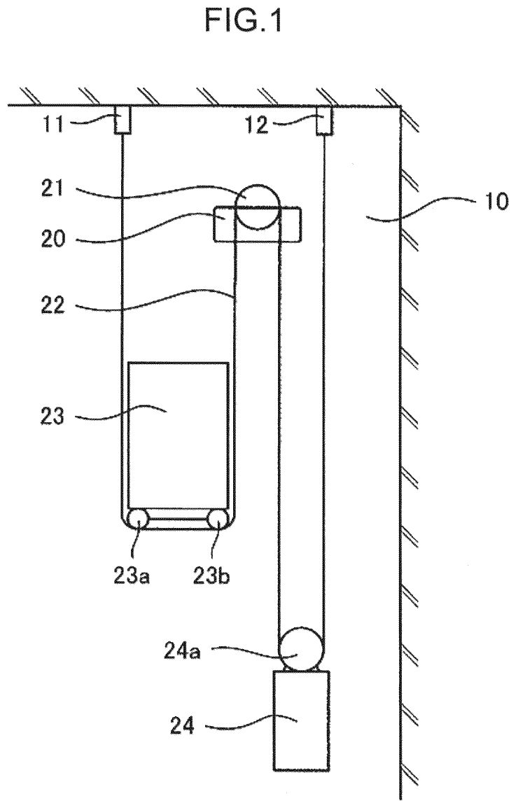

A sheave for a lift according to a first embodiment is described. FIG. 1 is a view for illustrating an example of a configuration of a lift including a sheave for a lift according to this embodiment. In FIG. 1, a lift employing a 2:1 roping system is exemplified.

As illustrated in FIG. 1, a hoisting machine 20 is installed in an upper part of a hoistway 10. The hoisting machine 20 is fixed to a support beam (not shown) provided in the upper part of the hoistway 10.

The hoisting machine 20 includes a sheave 21, a hoisting machine motor (not shown), and a hoisting machine brake (not shown). The hoisting machine motor rotates the sheave 21. The hoisting machine brake holds the sheave 21 in a stationary state. Further, the hoisting machine brake brakes the rotation of the sheave 21.

A plurality of main ropes 22 are wound around the sheave 21. In FIG. 1, only one main rope 22 is illustrated.

A first rope stopper 11 and a second rope stopper 12 are provided in the upper part of the hoistway 10. One end of each of the main ropes 22 is connected to the first rope stopper 11. The other end of each of the main ropes 22 is connected to the second rope stopper 12.

A car 23 and a counterweight 24 are suspended by the plurality of main ropes 22 in the hoistway 10. The car 23 and the counterweight 24 are raised and lowered in the hoistway 10 through the rotation of the sheave 21.

A first car suspension sheave 23a and a second car suspension sheave 23b are provided at a lower part of the car 23. A weight suspension sheave 24a is provided at an upper part of the counterweight 24.

The plurality of main ropes 22 are wound around the first car suspension sheave 23a, the second car suspension sheave 23b, the sheave 21, and the weight suspension sheave 24a in the stated order from the first rope stopper 11 side.

In the lift illustrated in FIG. 1, the sheave for a lift according to this embodiment is used as at least one of the first car suspension sheave 23a, the second car suspension sheave 23b, the sheave 21, and the weight suspension sheave 24a.

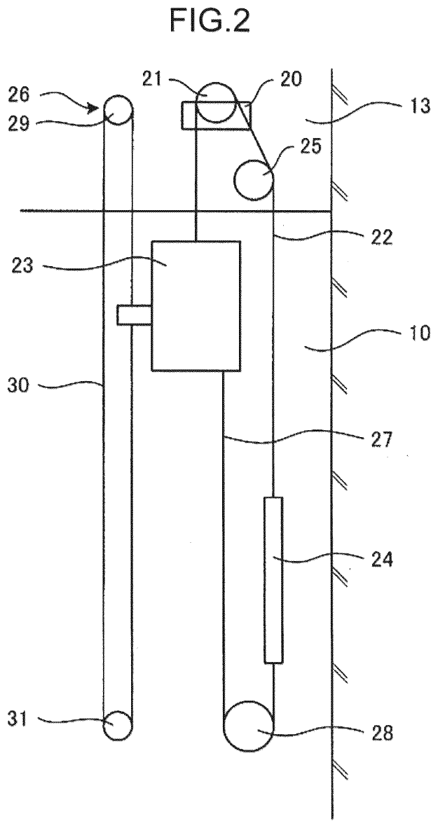

FIG. 2 is a view for illustrating another example of the configuration of the lift including the sheave for a lift according to this embodiment. In FIG. 2, a lift employing a 1:1 roping system is exemplified. As illustrated in FIG. 2, a machine room 13 is provided above a hoistway 10.

A hoisting machine 20, a deflector sheave 25, and a speed governor 26 are installed in the machine room 13. A plurality of main ropes 22 are wound around a sheave 21 of the hoisting machine 20 and the deflector sheave 25. A car 23 is connected to one end of each of the main ropes 22. A counterweight 24 is connected to the other end of each of the main ropes 22.

The car 23 and the counterweight 24 are suspended by the plurality of main ropes 22 in the hoistway 10. The car 23 and the counterweight 24 are raised and lowered in the hoistway 10 through rotation of the sheave 21.

A compensation rope 27 is suspended between a lower part of the car 23 and a lower part of the counterweight 24. The compensation rope 27 compensates for weight imbalance of the plurality of main ropes 22 on one side and on the other side of the sheave 21.

A compensating sheave 28 is provided in a lower part of the hoistway 10. The compensation rope 27 is wound around the compensating sheave 28. Tension is applied to the compensation rope 27 by the compensating sheave 28.

The speed governor 26 detects whether or not a speed of the car 23 has reached an overspeed. The speed governor 26 includes a speed governor sheave 29. A speed governor rope 30 is wound around the speed governor sheave 29.

The speed governor rope 30 is provided in an annular manner in the hoistway 10. The speed governor rope 30 is connected to the car 23. A tension sheave 31 is provided in the lower part of the hoistway 10. The speed governor rope 30 is wound around the tension sheave 31. When the car 23 is raised and lowered, the speed governor rope 30 is moved and circulated. The speed governor sheave 29 is rotated at a rotation speed corresponding to a traveling speed of the car 23.

In the lift illustrated in FIG. 2, the sheave for a lift according to this embodiment is used as at least one of the sheave 21, the deflector sheave 25, the compensating sheave 28, the speed governor sheave 29, and the tension sheave 31.

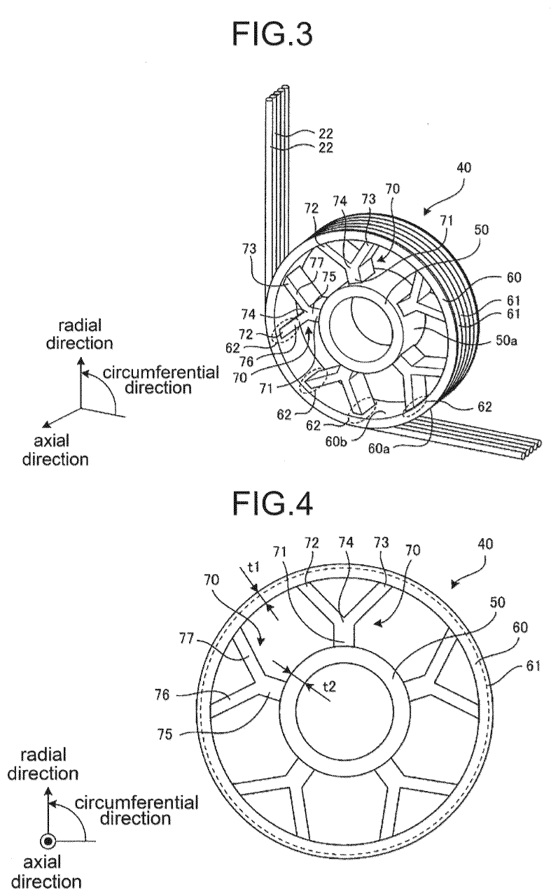

FIG. 3 is a perspective view for illustrating the configuration of the sheave for a lift according to this embodiment. In FIG. 3, a sheave 40 for a lift, which is used as the first car suspension sheave 23a of the lift illustrated in FIG. 1, is exemplified. As illustrated in FIG. 3, the sheave 40 for a lift includes a base member 50, a winding member 60, and a plurality of intermediate members 70. In this embodiment, the base member 50, the winding member 60, and the plurality of intermediate members 70 are formed integrally.

The base member 50 is a hub member having a cylindrical shape. The base member 50 holds a sheave shaft (not shown) therein through intermediation of a bearing (not shown). The sheave shaft serves as a rotary shaft of the sheave 40 for a lift.

The winding member 60 is coaxial with the base member 50 and has a cylindrical shape with a diameter larger than a diameter of the base member 50. The winding member 60 is arranged on an outer periphery side of the base member 50.

A direction along a center axis of the winding member 60 is hereinafter referred to as “axial direction of the winding member 60” or simply as “axial direction” in some cases. A direction along a circumference having the center axis of the winding member 60 as a center in cross section perpendicular to the axial direction of the winding member 60 is hereinafter referred to as “circumferential direction of the winding member 60” or simply as “circumferential direction” in some cases. In the same cross section, a direction along a radius of the winding member 60 is hereinafter referred to as “radial direction of the winding member 60” or simply as “radial direction” in some cases.

The plurality of main ropes 22 are wound around the winding member 60. A plurality of grooves 61, each extending in the circumferential direction of the winding member 60, are formed in an outer peripheral surface 60a of the winding member 60. The plurality of grooves 61 are arranged side by side in the axial direction of the winding member 60 so as to be in parallel to each other. The main ropes 22 are held in the grooves 61 in a one-to-one manner.

The intermediate members 70 are provided between the base member 50 and the winding member 60 in the radial direction of the winding member 60. The intermediate members 70 connect the base member 50 and the winding member 60 to each other. The plurality of intermediate members 70 are arranged equiangularly.

The intermediate members 70 extend from an outer peripheral surface 50a of the base member 50 to an inner peripheral surface 60b of the winding member 60. Each of the intermediate members 70 has a branch structure that branches out in a direction toward the winding member 60 in cross section perpendicular to the axial direction. In this embodiment, each of the intermediate members 70 has a Y-like shape in cross section perpendicular to the axial direction.

Each of the intermediate members 70 has a first end portion 71, a second end portion 72, and a third end portion 73. The first end portion 71 is connected to the outer peripheral surface 50a of the base member 50. The second end portion 72 is connected to the inner peripheral surface 60b of the winding member 60. The third end portion 73 is connected to the inner peripheral surface 60b of the winding member 60 at a position different from a position at which the second end portion 72 is connected to the winding member 60 in the circumferential direction of the winding member 60. When viewed in the radial direction of the winding member 60, the second end portions 72 and the third end portions 73 are arranged, for example, so as to overlap all the grooves 61.

A portion of the winding member 60 to which the second end portion 72 or the third end portion 73 is connected corresponds to a supported portion 62. The winding member 60 is supported by the intermediate members 70 at a plurality of the supported portions 62.

Each of the intermediate members 70 includes a branch portion 74, a first leg portion 75, a second leg portion 76, and a third leg portion 77. The branch portion 74 is formed between the first end portion 71 and each of the second end portion 72 and the third end portion 73. The branch portion 74 and the first end portion 71 are connected to each other by the first leg portion 75. The first leg portion 75 extends linearly in the radial direction of the winding member 60 in cross section perpendicular to the axial direction.

The branch portion 74 and the second end portion 72 are connected to each other by the second leg portion 76. The second leg portion 76 extends linearly in cross section perpendicular to the axial direction. In the same cross section, a direction in which the second leg portion 76 extends is inclined with respect to the radial direction of the winding member 60.

The branch portion 74 and the third end portion 73 are connected to each other by the third leg portion 77. The third leg portion 77 extends linearly in cross section perpendicular to the axial direction. In the same cross section, a direction in which the third leg portion 77 extends is inclined to a direction opposite to the direction in which the second leg portion 76 extends with respect to the radial direction of the winding member 60.

In this embodiment, each of the intermediate members 70 has a Y-like shape. However, each of the intermediate members 70 may have a V-like shape in cross section perpendicular to the axial direction. When each of the intermediate members 70 has a V-like shape, a distance between the branch portion 74 and the first end portion 71 is reduced. Thus, the first leg portion 75 may be substantially omitted.

In this embodiment, five intermediate members 70 are provided. However, the number of intermediate members 70 may be two or more or four or less, or may be six or more.

As described above, the sheave 40 for a lift according to this embodiment includes the base member 50, the winding member 60, and the plurality of intermediate members 70. The base member 50 has a cylindrical shape. The winding member 60 is coaxial with the base member 50 and has a cylindrical shape with a diameter larger than the diameter of the base member 50. The plurality of intermediate members 70 are provided between the base member 50 and the winding member 60 in the radial direction of the winding member 60.

Each of the plurality of intermediate members 70 has the first end portion 71, the second end portion 72, the third end portion 73, and the branch portion 74. The first end portion 71 is connected to the base member 50. The second end portion 72 is connected to the winding member 60. The third end portion 73 is connected to the winding member 60 at the position different from the position at which the second end portion 72 is connected to the winding member 60 in the circumferential direction. The branch portion 74 is formed between the first end portion 71 and each of the second end portion 72 and the third end portion 73.

Tension corresponding to a sum of weight of the car 23 and weight of a passenger (passengers) in the car 23 is generated in the plurality of main ropes 22 that are wound around the sheave 40 for a lift. A radial load corresponding to the tension of the plurality of main ropes 22 is applied to the winding member 60 in a direction toward a center axis. Thus, bending deformation in a direction toward the center axis may occur in the winding member 60. In particular, when a distance between two supported portions 62 adjacent to each other in the circumferential direction is increased, the bending deformation that occurs in the winding member 60 between the two supported portions 62 is liable to be increased.

When the above-mentioned bending deformation periodically and repeatedly occurs along with the rotation of the sheave 40 for a lift, oscillation corresponding to a deformation amount of the winding member 60 is transmitted to the car 23. In order to reduce the oscillation that is transmitted to the car 23, it is important to decrease the deformation amount of the winding member 60.

In this embodiment, each of the intermediate members 70 supports the winding member 60 at the second end portion 72 and the third end portion 73. Thus, the distance between two supported portions 62 adjacent to each other in the circumferential direction can be decreased in this embodiment in comparison to that in a configuration in which each intermediate member supports a winding member at only one end portion of the intermediate member. Thus, a bending deformation amount of the winding member 60, which is generated between two supported portions 62, can be reduced. Thus, the oscillation transmitted from the sheave 40 for a lift to the car 23 can be reduced, and hence degradation of ride comfort of the car 23 can be suppressed.

An abrasion amount of the grooves 61 depends on the deformation amount of the winding member 60. According to this embodiment, the deformation amount of the winding member 60, which is generated between two supported portions 62, can be decreased. Hence, the abrasion amount of the grooves 61 can be uniformized in the circumferential direction of the winding member 60. Thus, according to this embodiment, the degradation of ride comfort of the car 23 over time can be suppressed.

In this embodiment, the intermediate member 70 has a branch structure. Thus, structural strength of the intermediate members 70 can be enhanced. As a result, the deformation of the intermediate members 70 in the circumferential direction of the winding member 60 can be suppressed. Thus, a stress generated in the intermediate members 70 is decreased, and hence the intermediate members 70 can be reduced in weight. As a result, moment of inertia of the sheave 40 for a lift can be reduced as a whole, and control at the time of acceleration and deceleration is facilitated. Accordingly, the ride comfort of the car 23 can be improved.

Further, the deformation of the intermediate members 70 in the circumferential direction of the winding member 60 can be suppressed, and hence the deformation amount of the winding member 60 in the circumferential direction can be reduced. Thus, a shift amount of each of the main ropes 22 that are wound around the winding member 60 in an axial direction of the rope can be reduced, and hence the ride comfort of the car 23 can be improved.

### Second Embodiment

A sheave for a lift according to a second embodiment is described. FIG. 4 is a front view for illustrating a configuration of a sheave for a lift according to this embodiment. Components having the same functions and actions as those of the components according to the first embodiment are denoted by the same reference symbols, and description thereof is omitted.

As illustrated in FIG. 4, in a sheave 40 for a lift according to this embodiment, a wall thickness t1 of a winding member 60 in a radial direction of the winding member 60 and a wall thickness t2 of a base member 50 in the radial direction of the winding member 60 are the same (t1=t2).

The sheave 40 for a lift according to this embodiment is manufactured by casting. In this embodiment, the base member 50, the winding member 60, and a plurality of intermediate members 70 are formed integrally. When the wall thickness t1 of the winding member 60 is larger than the wall thickness t2 of the base member 50 (t1>t2), the winding member 60 cools and hardens after the base member 50 does at the time of casting. Thus, the winding member 60 tends to have an internal defect of a cast, such as a shrinkage cavity.

A plurality of grooves 61 are formed in the winding member 60. Thus, after being cast, a larger amount of processing is performed on the winding member 60 than on the base member 50. Hence, an internal defect of the winding member 60 is liable to be exposed on a surface of the product. Thus, product strength of the sheave 40 for a lift is reduced in some cases.

Meanwhile, when the wall thickness t1 of the winding member 60 is smaller than the wall thickness t2 of the base member 50 (t1<t2), the base member 50 cools and hardens after the winding member 60 does at the time of casting. At the time of cooling and hardening, the intermediate members 70 are pulled in a direction toward a center axis of the sheave 40 for a lift due to solidification shrinkage that occurs along with a transformation in metal structure and thermal shrinkage caused by a decrease in temperature. Strength of the intermediate member 70 is lower than each of strength of the base member 50 and strength of the winding member 60. Thus, when a tensile stress generated in the intermediate members 70 exceeds an allowable stress, a crack may be formed in the intermediate members 70.

In order to suppress occurrence of an internal defect and formation of a crack at the time of manufacture of the sheave 40 for a lift and to reduce a product defective rate, it is desired that the base member 50 and the winding member 60 cool and harden at the same time.

In this embodiment, the wall thickness t1 of the winding member 60 and the wall thickness t2 of the base member 50 are the same. Hence, the base member 50 and the winding member 60 can cool and harden at the same time. Thus, according to this embodiment, the occurrence of an internal defect and the formation of a crack at the time of manufacture of the sheave 40 for a lift can be suppressed, and hence the product defective rate can be reduced.

As described above, in the sheave 40 for a lift according to this embodiment, the wall thickness t1 of the winding member 60 in the radial direction of the winding member 60 and the wall thickness t2 of the base member 50 in the radial direction are the same.

With the configuration described above, the base member 50 and the winding member 60 are uniformly cooled at the time of casting of the sheave 40 for a lift. Thus, an internal defect such as a shrinkage cavity, which tends to occur especially in the winding member 60, can be prevented. Further, the internal stress that is generated at the time of solidification of a molten metal is reduced, and hence the formation of a crack can be suppressed.

### Third Embodiment

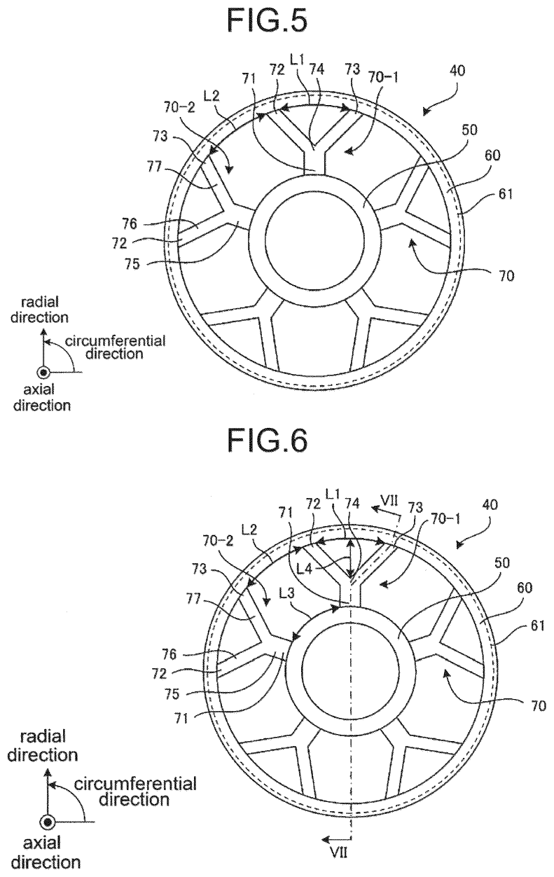

A sheave for a lift according to a third embodiment is described. FIG. 5 is a front view for illustrating a configuration of a sheave for a lift according to this embodiment. Components having the same functions and actions as those of the components according to the first embodiment or the second embodiment are denoted by the same reference symbols, and description thereof is omitted.

As illustrated in FIG. 5, a plurality of intermediate members 70 include a first intermediate member 70-1 and a second intermediate member 70-2. The first intermediate member 70-1 and the second intermediate member 70-2 are adjacent to each other in a circumferential direction of a winding member 60. Each of the first intermediate member 70-1 and the second intermediate member 70-2 has a second end portion 72 and a third end portion 73.

The second end portion 72 of the first intermediate member 70-1 and the third end portion 73 of the same first intermediate member 70-1 are adjacent to each other in the circumferential direction. Further, the second end portion 72 of the first intermediate member 70-1 and the third end portion 73 of the second intermediate member 70-2 are adjacent to each other in the circumferential direction.

Here, a distance between the second end portion 72 of the first intermediate member 70-1 and the third end portion 73 of the first intermediate member 70-1 in the circumferential direction is represented by L1. A distance between the second end portion 72 of the first intermediate member 70-1 and the third end portion 73 of the second intermediate member 70-2 in the circumferential direction is represented by L2. In this embodiment, the distance L1 and the distance L2 are the same (L1=L2).

When the distance L1 and the distance L2 are different from each other, the portion with a longer distance has larger deformation in the winding member 60. Thus, a deformation amount of the winding member 60 becomes nonuniform in the circumferential direction. As a result, periodic oscillation is transmitted to a car 23 in some cases.

Meanwhile, in this embodiment, the distance L1 and the distance L2 are the same. Thus, non-uniformity in the deformation amount of the winding member 60 in the circumferential direction can be reduced. Further, in this embodiment, maximum values of the distance L1 and the distance L2 can be minimized. Hence, the deformation of the winding member 60 can be further reduced. Thus, degradation of ride comfort of the car 23 can be further suppressed.

As described above, in a sheave 40 for a lift according to this embodiment, the plurality of intermediate members 70 include the first intermediate member 70-1 and the second intermediate member 70-2 that are adjacent to each other in the circumferential direction. The second end portion 72 of the first intermediate member 70-1 and the third end portion 73 of the second intermediate member 70-2 are adjacent to each other in the circumferential direction. The distance L1 between the second end portion 72 of the first intermediate member 70-1 and the third end portion 73 of the first intermediate member 70-1 in the circumferential direction and the distance L2 between the second end portion 72 of the first intermediate member 70-1 and the third end portion 73 of the second intermediate member 70-2 in the circumferential direction are the same.

In the configuration described above, the distance L1 and the distance L2 are the same. Thus, the non-uniformity in the deformation amount of the winding member 60 in the circumferential direction can be reduced. Further, with the configuration described above, the maximum values of the distance L1 and the distance L2 can be minimized. Thus, the deformation of the winding member 60 can be further reduced. Accordingly, the degradation of ride comfort of the car 23 can be further suppressed.

### Fourth Embodiment

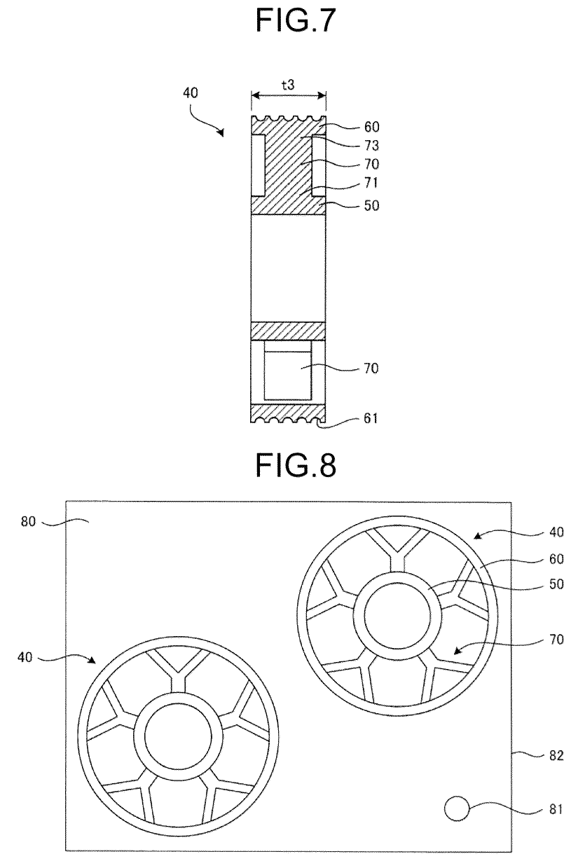

A sheave for a lift according to a fourth embodiment is described. FIG. 6 is a front view for illustrating a configuration of a sheave for a lift according to this embodiment. FIG. 7 is a sectional view taken along the line VII-VII of FIG. 6. Components having the same functions and actions as those of the components according to any of the first to third embodiments are denoted by the same reference symbols, and description thereof is omitted.

A sheave 40 for a lift illustrated in FIG. 6 and FIG. 7 is manufactured by sand casting. Now, a distance between a first end portion 71 of a first intermediate member 70-1 and a first end portion 71 of a second intermediate member 70-2 in the circumferential direction is represented by L3. A distance between a branch portion 74 of the first intermediate member 70-1 and a winding member 60 in the radial direction is represented by L4. A thickness of the winding member 60 in the axial direction is represented by t3.

As in the third embodiment, a distance between a second end portion 72 of the first intermediate member 70-1 and a third end portion 73 of the first intermediate member 70-1 in the circumferential direction is represented by L1. A distance between the second end portion 72 of the first intermediate member 70-1 and the third end portion 73 of the second intermediate member 70-2 in the circumferential direction is represented by L2.

In this embodiment, each of the distance L1, the distance L2, the distance L3, and the distance L4 is 0.3 time or more the thickness t3. Specifically, the distance L1 and the thickness t3 satisfy a relationship of: L1≥0.3×t3. The distance L2 and the thickness t3 satisfy a relationship of: L2≥0.3×t3. The distance L3 and the thickness t3 satisfy a relationship of: L3≥0.3×t3. The distance L4 and the thickness t3 satisfy a relationship of: L4≥0.3×t3.

The thickness t3 corresponds to a height of a sand mold formed at the time of casting. Each of the distance L1, the distance L2, the distance L3, and the distance LA corresponds to a thickness of the sand mold. When the thickness of the sand mold is smaller than the height of the sand mold, strength of the sand mold decreases. Thus, the sand mold is liable to collapse due to a molten metal pressure at the time of pouring. When the sand mold collapses at the time of casting, collapsing sand flows into a product and thus may cause a product defect. When the thickness of the sand mold is remarkably small with respect to the height of the sand mold, the formation of the sand mold itself becomes difficult in some cases. In order to suppress a product defect caused due to the sand mold, it is required that the sand mold be ensured to have a given thickness or larger with respect to the height of the sand mold.

In this embodiment, each of the distance L1, the distance L2, the distance L3, and the distance L4 is 0.3 time or more the thickness t3. Thus, the sand mold can be ensured to have a given thickness or larger with respect to the height of the sand mold. Thus, the strength of the sand mold, which is required for the casting of the sheave 40 for a lift, can be ensured. Hence, a product defect, which is caused due to the sand mold, can be suppressed. Accordingly, a manufacturing yield of the sheave 40 for a lift can be improved.

As described above, in the sheave 40 for a lift according to this embodiment, the plurality of intermediate members 70 include the first intermediate member 70-1 and the second intermediate member 70-2 that are adjacent to each other in the circumferential direction. The distance between the second end portion 72 of the first intermediate member 70-1 and the third end portion 73 of the first intermediate member 70-1 in the circumferential direction is represented by L1. The distance between the second end portion 72 of the first intermediate member 70-1 and the third end portion 73 of the second intermediate member 70-2 in the circumferential direction is represented by L2. The distance between the first end portion 71 of the first intermediate member 70-1 and the first end portion 71 of the second intermediate member 70-2 in the circumferential direction is represented by L3. The distance between the branch portion 74 of the first intermediate member 70-1 and the winding member 60 in the radial direction is represented by L4. In this case, each of the distance L1, the distance L2, the distance L3, and the distance L4 is 0.3 time or more the thickness t3 of the winding member 60 in the axial direction of the winding member 60.

With the configuration described above, the strength of the sand mold, which is required for the casting of the sheave 40 for a lift, can be ensured. Thus, a product defect caused due to the sand mold can be suppressed.

### Fifth Embodiment

A sheave for a lift according to a fifth embodiment is described. First, a comparative example of this embodiment is described. FIG. 8 is a view for illustrating an example of a casting design used when a sheave for a lift according to the comparative example of this embodiment is manufactured. In the casting design illustrated in FIG. 8, two sheaves 40 for a lift are arranged inside a molding flask 82 serving as an outer frame for a casting sand mold 80. A pouring gate 81 is arranged at a position away from both of the two sheaves 40 for a lift in plan view. In order to improve a yield in a casting step and reduce manufacturing cost of products, it is desirable that as many products as possible be arranged inside the molding flask 82 in the casting design.

In this comparative example, however, a base member 50, a winding member 60, and intermediate members 70 are formed as an integrated body, and hence a product size is large in consideration of a size of the molding flask 82. Thus, an area inside the molding flask 82, in which the products cannot be arranged, is large. Hence, a yield in the casting step is lowered and manufacturing cost of the products increases in this comparative example.

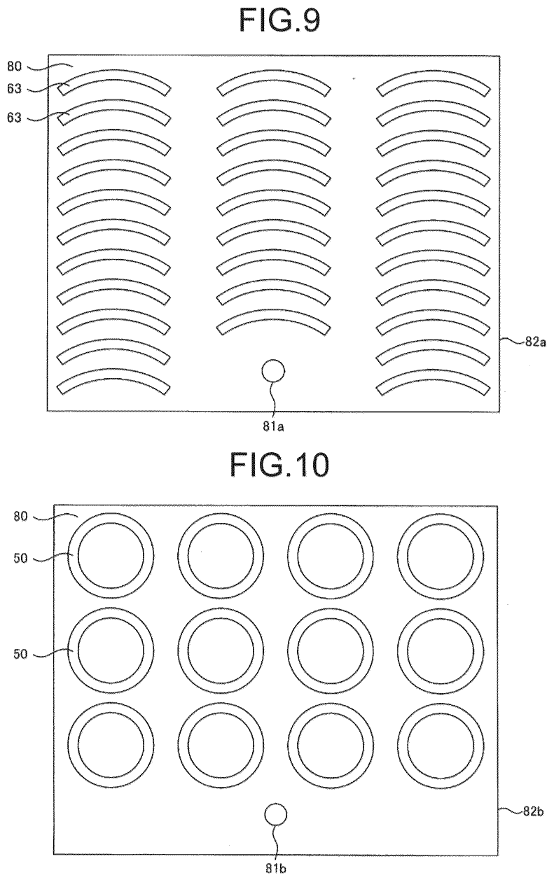

FIG. 9 to FIG. 11 are views each for illustrating an example of a casting design used when the sheave for a lift according to this embodiment is manufactured. In this embodiment, a winding member 60, a base member 50, and each of a plurality of intermediate members 70 are formed as bodies that are separate from each other. Further, the winding member 60 is divided into a plurality of divided parts 63 in the circumferential direction. The divided parts 63, the base members 50, and the intermediate members 70 are produced with use of different molding flasks 82a, 82b, and 82c, respectively. Sizes of the molding flasks 82a, 82b, and 82c are, for example, the same as the size of the molding flask 82.

In a casting design illustrated in FIG. 9, the plurality of divided parts 63 are arranged inside the molding flask 82a. Each of the divided parts 63 has a partial cylindrical shape. In this embodiment, the winding member 60 is formed by joining five divided parts 63 into a cylindrical shape after the casting step. A pouring gate 81a is arranged at a position away from all the plurality of divided parts 63 in plan view. A size of each of the divided parts 63 is smaller than a size of the sheave 40 for a lift. Thus, a larger number of divided parts 63 can be efficiently arranged inside the molding flask 82a. Hence, an area inside the molding flask 82a, in which the divided parts 63 are not arranged, is smaller than the area inside the molding flask 82 of the comparative example illustrated in FIG. 8, in which the products are not arranged.

In a casting design illustrated in FIG. 10, a plurality of base members 50 are arranged inside the molding flask 82b. A pouring gate 81b is arranged at a position away from all the plurality of base members 50 in plan view. A size of each of the base members 50 is smaller than a size of the sheave 40 for a lift. Thus, a larger number of base members 50 can be efficiently arranged inside the casing flask 82b. Hence, an area inside the molding flask 82b, in which the base members 50 are not arranged, is smaller than the area inside the molding flask 82 of the comparative example illustrated in FIG. 8, in which the products are not arranged.

In a casting design illustrated in FIG. 11, a plurality of intermediate members 70 are arranged inside the casting flask 82c. A pouring gate 81c is arranged at a position away from all the plurality of intermediate members 70 in plan view. A size of each of the intermediate members 70 is smaller than a size of the sheave 40 for a lift. Thus, a larger number of intermediate members 70 can be efficiently arranged inside the molding flask 82c. Thus, an area inside the molding flask 82c, in which the intermediate members 70 are not arranged, is smaller than the area inside the molding flask 82 of the comparative example illustrated in FIG. 8, in which the products are not arranged.

In this embodiment, the sheave 40 for a lift is divided into the plurality of parts. The parts are casted with use of different molding flasks 82a, 82b, and 82c. Efficiency in the arrangement of the components can be improved for each of the molding flasks 82a, 82b, and 82c. Thus, a yield in the casting step can be improved. Accordingly, the manufacturing cost of the sheave 40 for a lift can be reduced.

As described above, in the sheave 40 for a lift according to this embodiment, each of the plurality of intermediate members 70, the base member 50, and the winding member 60 are formed as bodies that are separate from each other.

With the configuration described above, the intermediate members 70, the base member 50, and the winding member 60 can be formed by casting with use of different molding flasks 82a, 82b, and 82c. Thus, the efficiency in the arrangement of the members can be improved for each of the molding flasks 82a, 82b, and 82c. Accordingly, the yield in the casting step can be improved, and the manufacturing cost of the sheave 40 for a lift can be reduced.

Further, in the configuration described above, the sheave 40 for a lift is divided into the plurality of parts. Thus, a size of each part can be made smaller than the size of the sheave 40 for a lift. Hence, an increase in internal stress generated due to solidification shrinkage and thermal shrinkage in the casting step can be suppressed. Accordingly, the formation of a crack in the intermediate members 70, the base member 50, and the winding member 60 can be prevented.

### Sixth Embodiment

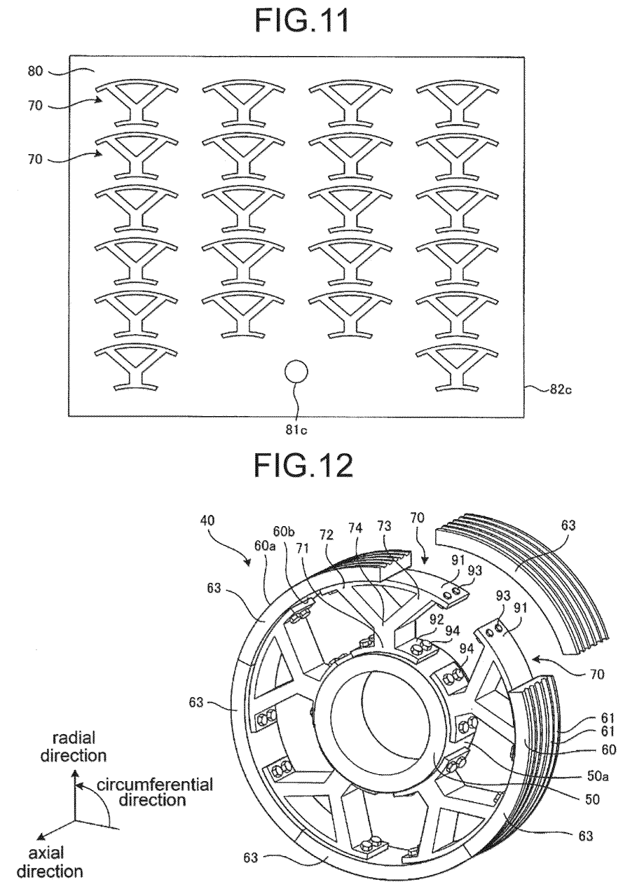

A sheave for a lift according to a sixth embodiment is described. FIG. 12 is a perspective view for illustrating a configuration of a sheave for a lift according to this embodiment. Components having the same functions and actions as those of the components according to any of the first to fifth embodiments are denoted by the same reference symbols, and description thereof is omitted.

As illustrated in FIG. 12, a sheave 40 for a lift includes a base member 50, a winding member 60, and a plurality of intermediate members 70. The base member 50, the winding member 60, and each of the plurality of the intermediate members 70 are formed as bodies that are separate from each other. Further, the winding member 60 is divided into a plurality of divided parts 63 in the circumferential direction. In this embodiment, the number of divided parts 63 for forming one winding member 60 is the same as the number of intermediate members 70. Each of the divided parts 63 has a partial cylindrical shape.

Each of the intermediate members 70 has a coupling portion 91 and a coupling portion 92. The coupling portion 91 is formed so as to extend between a second end portion 72 and a third end portion 73 of each of the intermediate members 70. Further, the coupling portion 91 protrudes outward in a flange-like fashion from the second end portion 72 and the third end portion 73 in the circumferential direction. The coupling portion 91 has a partial cylindrical shape extending along an inner peripheral surface 60b of the winding member 60. Bolt holes through which hexagon head bolts 93 are inserted are formed in the coupling portion 91. Each of the divided parts 63 is removably coupled to at least one intermediate member 70 with use of the hexagon head bolts 93. In this embodiment, each of the divided parts 63 is removably coupled to two coupling portions 91 that are adjacent to each other in the circumferential direction with use of the hexagon head bolts 93.

The coupling portion 92 is formed at a first end portion 71 of each of the intermediate members 70. The coupling portion 92 protrudes outward in a flange-like fashion from the first end portion 71 in the circumferential direction. The coupling portion 92 has a partial cylindrical shape extending along an outer peripheral surface 50a of the base member 50. Bolt holes through which hexagon head bolts 94 are inserted are formed in the coupling portion 92. The coupling portion 92 of each of the intermediate members 70 is coupled to the base member 50 with use of the hexagon head bolts 94.

In a case of a traction type lift, abrasion occurs in grooves of a winding member due to contact with main ropes. When an abrasion amount of the grooves increases, inconvenience such as excessive tension of the main ropes or early degradation of the main ropes occurs in some cases. Thus, it is common to use a material having abrasion resistance, such as a ferrum casting ductile (FCD) material, as a material for forming the winding member. Meanwhile, when an FCD material is used, a casting defect is more liable to be caused at the time of manufacture in comparison to a case in which a ferrum casting (FC) material is used. Thus, a yield tends to be low. Further, a material unit price of the FCD material is higher than a material unit price of the FC material. Thus, when the FCD material is used for the entire sheave for a lift, a product cost of the sheave for a lift disadvantageously increases.

The winding member 60 according to this embodiment is made of a material that is different from both of a material of the plurality of the intermediate members 70 and a material of the base member 50. The winding member 60 is made of an FCD material. The plurality of intermediate members 70 and the base member 50 are made of an FC material. Thus, an appropriate material can be used for each of the components of the sheave 40 for a lift. Thus, according to this embodiment, development of the abrasion of the grooves 61 can be suppressed, and product cost of the sheave 40 for a lift can be reduced.

In this embodiment, the plurality of intermediate members 70 and the base member 50 are made of the same material. However, the plurality of intermediate members 70 and the base member 50 may be made of materials that are different from each other. Further, when the plurality of intermediate members 70 and the base member 50 are made of the same material, the plurality of intermediate members 70 and the base member 50 may be formed integrally.

Further, in a case of a traction type lift, the abrasion of the grooves develops over time. In general, when the abrasion of the grooves has developed, the sheave for a lift is replaced by a new one. However, particularly in some large-capacity lifts, a size of the sheave for a lift is larger than a size of a passageway to a machine room. In such a case, it is sometimes difficult to replace the sheave for a lift because it is physically difficult to carry the sheave for a lift to an outside.

The winding member 60 according to this embodiment is divided into the plurality of divided parts 63 in the circumferential direction. Each of the divided parts 63 is removably coupled to at least one intermediate member 70 with use of the hexagon head bolts 93. Thus, each of the divided parts 63 can easily be removed from the sheave 40 for a lift, and each of the divided member 63 can easily be carried out from a machine room 13. Accordingly, when the abrasion of any of the plurality of grooves 61 has developed, the winding member 60 alone can easily be replaced. Thus, maintenance cost for a lift can be reduced.

As described above, in the sheave 40 for a lift according to this embodiment, the winding member 60 is made of a material that is different from a material of the base member 50 and a material of the plurality of intermediate members 70. With this configuration, an appropriate material can be used for each of the components of the sheave 40 for a lift.

In the sheave 40 for a lift according to this embodiment, the winding member 60 is divided into the plurality of divided parts 63 in the circumferential direction. Each of the plurality of divided parts 63 is coupled to at least one of the plurality of intermediate members 70 with use of the hexagon head bolts 93. In this case, the hexagon head bolt 93 is an example of a bolt. With the configuration described above, the replacement of the winding member 60 is facilitated, and hence the maintenance cost for a lift can be reduced.

The first to sixth embodiments described above may be carried out in various combinations.

### REFERENCE SIGNS LIST

10 hoistway, 11 first rope stopper, 12 second rope stopper, 13 machine room, 20 hoisting machine, 21 sheave, 22 main rope, 23 car, 23a first car suspension sheave, 23b second car suspension sheave, 24 counterweight, 24a weight suspension sheave, 25 deflector sheave, 26 speed governor, 27 compensation rope, 28 compensating sheave, 29 speed governor sheave, 30 speed governor rope, 31 tension sheave, 40 sheave for lift, 50 base member, 50a outer peripheral surface, 60 winding member, 60a outer peripheral surface, 60b inner peripheral surface, 61 groove, 62 supported portion, 63 divided part, 70 intermediate member, 70-1 first intermediate member, 70-2 second intermediate member, 71 first end portion, 72 second end portion, 73 third end portion, 74 branch portion, 75 first leg portion, 76 second leg portion, 77 third leg portion, 80 casting sand mold, 81, 81a, 81b, 81c pouring gate, 82, 82a, 82b, 82c molding flask, 91, 92 coupling portion, 93, 94 hexagon head bolt

1. A sheave for a lift, comprising:
a base member having a cylindrical shape:
a winding member that is coaxial with the base member and has a cylindrical shape with a diameter larger than a diameter of the base member; and
a plurality of intermediate members provided between the base member and the winding member in a radial direction of the winding member,
wherein each of the plurality of intermediate members includes:
a first end portion connected to the base member:
a second end portion connected to the winding member;
a third end portion connected to the winding member at a position different from a position at which the second end portion is connected to the winding member in a circumferential direction of the winding member; and
a branch portion formed between the first end portion and each of the second end portion and the third end portion.

2. The sheave for a lift according to claim 1, wherein a wall thickness of the winding member in the radial direction and a wall thickness of the base member in the radial direction are the same.

3. The sheave for a lift according to claim 1,
wherein the plurality of intermediate members include a first intermediate member and a second intermediate member that are adjacent to each other in the circumferential direction,
wherein the second end portion of the first intermediate member and the third end portion of the second intermediate member are adjacent to each other in the circumferential direction, and
wherein a distance between the second end portion of the first intermediate member and the third end portion of the first intermediate member in the circumferential direction and a distance between the second end portion of the first intermediate member and the third end portion of the second intermediate member in the circumferential direction are the same.

4. The sheave for a lift according to claim 1,
wherein the plurality of intermediate members include a first intermediate member and a second intermediate member that are adjacent to each other in the circumferential direction, and
wherein each of a distance between the second end portion of the first intermediate member and the third end portion of the first intermediate member in the circumferential direction, a distance between the second end portion of the first intermediate member and the third end portion of the second intermediate member in the circumferential direction, a distance between the first end portion of the first intermediate member and the first end portion of the second intermediate member in the circumferential direction, and a distance between the branch portion of the first intermediate member and the winding member in the radial direction is 0.3 time or more a thickness of the winding member in an axial direction of the winding member.

5. The sheave for a lift according to claim 1, wherein each of the plurality of intermediate members, the base member, and the winding member are formed as bodies that are separate from each other.

6. The sheave for a lift according to claim 1, wherein the winding member is made of a material that is different from a material of the base member and a material of the plurality of intermediate members.

7. The sheave for a lift according to claim 1,
wherein the winding member is divided into a plurality of divided parts in the circumferential direction, and
wherein each of the plurality of divided parts is coupled to at least one of the plurality of intermediate members with use of a bolt.
